(19) United States
(12) Patent Application Publication
(10) Pub. No.: US 2017/0235558 A1
(43) Pub. Date: Aug. 17, 2017

(54) SYSTEM AND METHOD FOR RECAPTURE AND REBUILD OF APPLICATION DEFINITION FROM INSTALLED INSTANCE

(71) Applicant: NetSuite Inc., San Mateo, CA (US)

(72) Inventors: Mariano Saenz, San Carlos, CA (US); Rajesh Manjrekar, San Jose, CA (US); Suhas Rohit Mehta, Santa Clara, CA (US)

(21) Appl. No.: 14/620,065

(22) Filed: Feb. 11, 2015

Related U.S. Application Data
(60) Provisional application No. 61/970,712, filed on Mar. 26, 2014.

(51) Int. Cl. G06F 9/445

(52) U.S. Cl. CPC G06F 8/61

(57) ABSTRACT

A system and method are shown for automatically regenerating an application installer from an application instance installed in a computing environment that involves collecting information for objects installed in the computing environment for an installed application, creating an installer map showing a plan for linked objects related to the installed application, adding a copy of the linked objects to an application installer package for the installed application, and creating a regenerated application installer based on the application installer package for the installed application.

### CROSS REFERENCE TO RELATED APPLICATIONS

This application claims the benefit of priority to U.S. Patent Application No. 61/970,712, filed Mar. 26, 2014, entitled “System and Method for Recapture and Rebuild of Application Definition from Installed Instance,” which is incorporated by reference herein in its entirety for all purposes.

### BACKGROUND

When a software application is installed on a device or system, it typically includes an application definition or installer that describes how the application is to be installed. Once the application is installed, the application definition is typically discarded or overwritten. For example, application installer packages (sometimes referred to as “bundles”) are sometimes tested by performing an installation for an account, such as a file system on an operating system or a cloud account, in a sandbox environment. However, conventional installation approaches generally only support installing files from an installer package. The installation data is often overwritten by other production data causing the application installer package information to be lost. This significantly complicates the making of incremental changes to the application installer for subsequent application distribution. Embodiments of the invention are directed toward solving these and other problems individually and collectively.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key, essential, or required features of the claimed subject matter, nor is it intended to be used in isolation to determine the scope of the claimed subject matter. The subject matter should be understood by reference to appropriate portions of the entire specification of this patent, any or all drawings and each claim.

Particularly in the case of cloud or multi-tenant platform application extensions, there are several instances where the original application installer may not be available. For example, for an online installer, e.g., a cloud based installation, a cloud application or an extension to an existing cloud application is created in a secure computing environment, e.g., a “sandbox”, and then installed in a production system. However, the online installer is lost when the sandbox is refreshed along with data as well as structure from the production system. As a consequence, the administrator is forced to recreate the installer, which requires significant resources and may lead to discrepancies with the cloud application as it is currently installed. Embodiments of the invention are directed toward providing a solution to this and other problems by permitting regeneration of an installer from an installed application in order to make incremental changes to the installer for subsequent application distribution.

An embodiment of the inventive method for automatically regenerating an application installer from an application instance installed in a computing environment involves collecting information for objects installed in the computing environment for an installed application, creating an installer map showing a plan for linked objects related to the installed application, adding a copy of the linked objects to an application installer package for the installed application, and creating a regenerated application installer based on the application installer package for the installed application. In one embodiment, the computing environment is a secure computing environment, such as a sandbox. In a further embodiment, the application installer is automatically regenerated when the secure computing environment is refreshed. In another embodiment, the secure computing environment replicates at least one of a distributed computing service and a distributed computing platform. In still another embodiment, the secure computing environment replicates at least one of a multi-tenant distributed computing service and a multi-tenant distributed computing platform. In yet another embodiment, the computing environment comprises at least one of a distributed computing service, a distributed computing platform, a multi-tenant distributed computing service, and a multi-tenant distributed computing platform.

In an embodiment of the inventive system for automatically recapturing and rebuilding an application installer from an application instance installed in a computing environment, the system is configured to collect information for objects installed in the computing environment for an installed application, create an installer map showing a plan for linked objects related to the installed application, add a copy of the linked objects to an application installer package for the installed application, and create a regenerated application installer based on the application installer package for the installed application.

In another embodiment, the invention includes a computer readable medium that has computer-executable instructions stored thereon which, when executed by a computer, will cause the computer to perform a process for automatically regenerating an application installer from an application installation in a computer environment, where the process involves collecting information for objects installed in the computing environment for an installed application, creating an installer map showing a plan for linked objects related to the installed application, adding a copy of the linked objects to an application installer package for the installed application, and creating a regenerated application installer based on the application installer package for the installed application.

Other objects and advantages of the present invention will be apparent to one of ordinary skill in the art upon review of the detailed description of the present invention and the included figures.

### BRIEF DESCRIPTION OF THE DRAWINGS

Various embodiments in accordance with the present disclosure will be described with reference to the drawings, in which:

FIG. 1 is a schematic diagram depicting aspects of an example computing environment in which an embodiment of the invention may be implemented;

FIG. 2 is a control flow diagram illustrating an example of a process for regenerating an installation package from an installed instance of an application in accordance with at least one embodiment of the invention;

FIG. 3 is a diagram illustrating elements or components of an example operating environment in which an embodiment of the invention may be implemented;

FIG. 4 is a diagram illustrating additional details of the elements or components of the multi-tenant distributed computing service platform of FIG. 3, in which an embodiment of the invention may be implemented; and

FIG. 5 is a schematic diagram depicting aspects of a non-limiting, exemplary computing environment suitable for implementing embodiments of at least some aspects of the present methods and systems and further depicting the relationship among a plurality of functional blocks suitable for implementing at least some aspects of the present methods and systems.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc. that is part of a client device, server, network element, or other form of computing or data processing device/platform) that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Existing technology typically only supports installing software application files from a package or installer onto a target system, e.g., a file system on an operating system or a cloud account. An installer is, for example, typically packaged in an installation package, which generally includes compiled code components and features as well as package logic with meta-data and system data that defines the execution of the installation package. Components may include files, directories, extension components, registry keys and other data that make up the application. Features are hierarchical groups of components such as, for example, the main program executable, the associated help files, auxiliary functions, and supporting data modules. Meta-data may include information describing the package, the identifier for the application, the application version and dependencies between components or modules.

Often, during development, an application is installed in a secure computing environment, such as a sandbox, to ensure that the application properly installs and functions before it is placed into production. For example, an efficient way to transfer an application to a production setting is by installing a package that was created or defined on a sandbox environment that matches the target (i.e., production) environment. However, after the application is moved to production, the sandbox environment is refreshed and the installer and related information is often lost. The administrator may be forced to recreate the definition manually in the sandbox environment in order, for example, to make incremental changes to the installer package. Manual recreation typically results in a new package identifier that is different from the production identifier for the application definition, which results in the production environment showing that a different application is installed with similar components. As a result, the recreated installer cannot perform an update on the production installation of the application.

Using an embodiment of the present invention, an application administrator, such as the author or original developer of the application, is able to regenerate the installer from an instance installed in a computing environment to subsequently support incrementally adding new functionality to the installer. Alternatively, the installer is regenerated automatically when a secure computing environment that is used to test the installation is refreshed. Once the installer is rebuilt, the administrator may further distribute or update and distribute the installer to target devices or accounts. This reduces the effort required to recreate or rewrite a new installer for either an entire application or for differential changes to an application (such as an extension to an application resident on a computing platform). For example, an application definition is restored in a sandbox environment to the state that was used for installation, including the original application identifier value, which allows an administrator to use the restored application definition to make differential changes to the application definition and then process an upgrade to the application in a production environment.

The computing environment from which the installation information is extracted may be a live computing environment, such as a computer or operating system platform, or a secure computing environment, such as a sandbox. Typically, a sandbox replicates, for purposes of testing or analysis, the functionality of an execution environment without exposing actual devices or servers and their data, code collections or distributions, or proprietary or public data to changes or code that could cause damage. New or altered applications, for example, are installed in the sandbox for testing to confirm or analyze their functionality before the application is released for distribution on live devices. Sandboxes may be utilized to replicate a wide variety of execution environments, such as a processor platform, an operating system platform, a distributed computing service, a distributed computing platform, or a multi-tenant distributed computing platform.

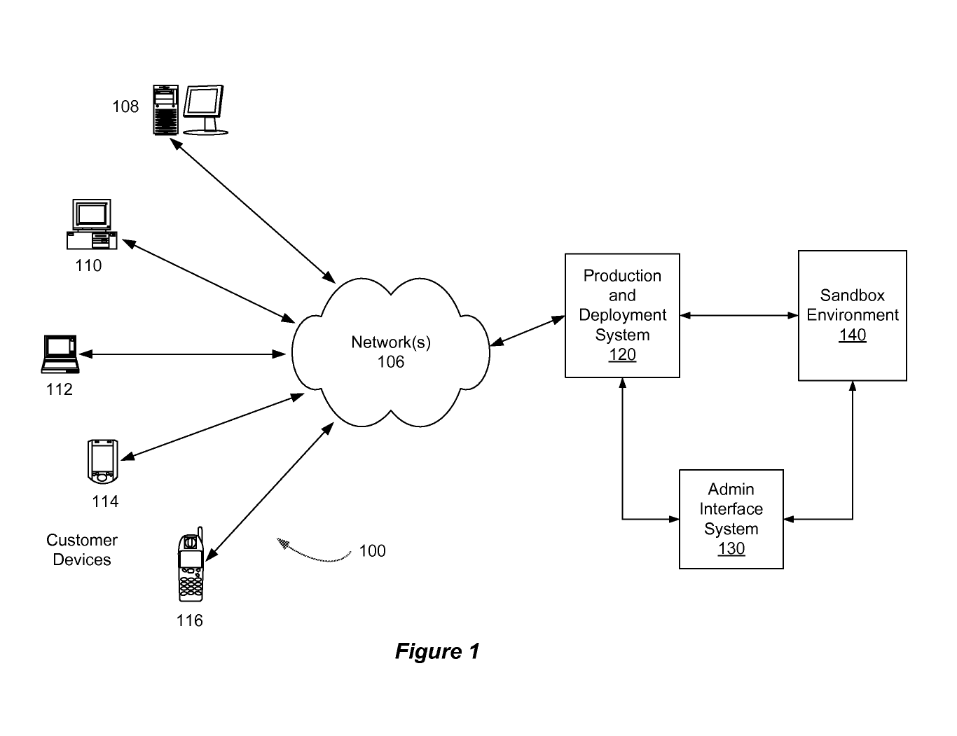

FIG. 1 is a schematic diagram depicting aspects of one example of a computing network architecture in which an embodiment of the invention may be implemented. As shown, a variety of clients 100 incorporating and/or incorporated into a variety of computing devices may communicate with a production and deployment system 120 through one or more networks 106. The production and deployment system 120, in this example, supports or communicates with an administrative interface system 130 and a sandbox environment 140. For example, a client may incorporate and/or be incorporated into a client application (e.g., software) implemented at least in part by one or more of the computing devices. Examples of suitable computing devices include personal computers, server computers 108, desktop computers 110, laptop computers 112, notebook computers, personal digital assistants (PDAs) 114, smart phones 116, cell phones, and consumer electronic devices incorporating one or more computing device components such as one or more processors, central processing units (CPU), or controllers. Examples of suitable networks 106 include networks utilizing wired and wireless communication technologies and networks operating in accordance with any suitable networking and/or communication protocol (e.g., the Internet). One of ordinary skill in the art will recognize that other computing devices and communication networks may be used to implement the invention.

In one embodiment of the invention, the application installation definition from a sandbox environment 140 is restored, which allows the administrator to make changes to the application definition using administrative interface system 130 and then process an upgrade on production installations of the application on production and deployment system 120. As a result of this regeneration, the developer may keep the existing installer updated to reflect changes to the application and provide a comprehensive installer. Having a single installer for the application has many advantages when tracking and distributing the application to the target systems, particularly for distributed or cloud-based systems. For example, maintenance may be limited to a single installer package instead of requiring tracking and maintenance of multiple installer packages. Similarly, the documentation otherwise required to ensure that the correct application is rebuilt in subsequent iterations may be reduced. In addition, functional loss or error in the application may be reduced by restoring the application to its original state.

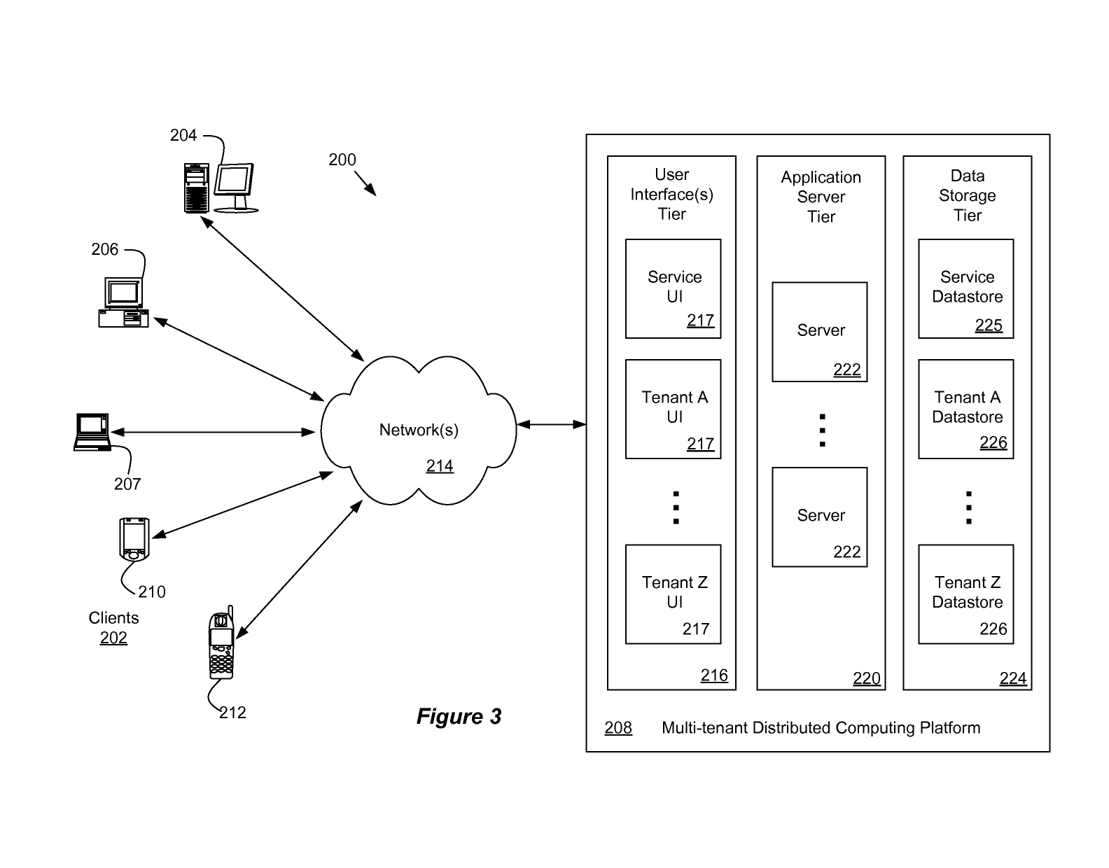

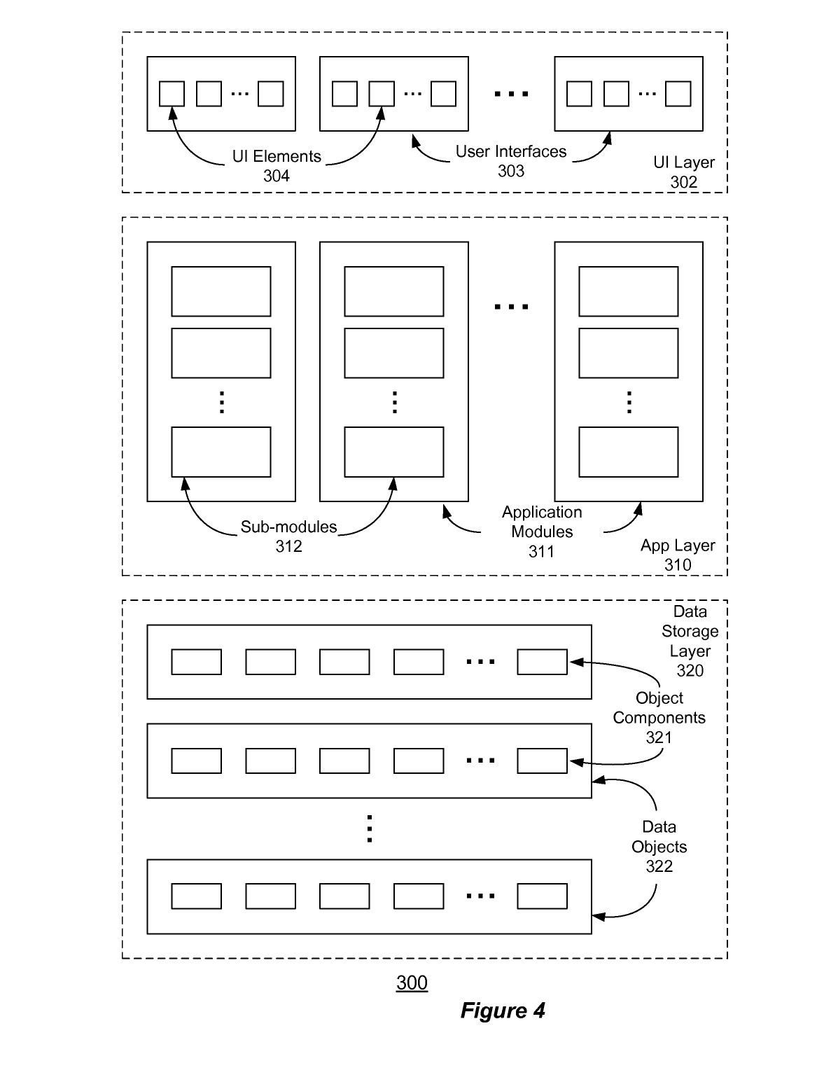

The architecture illustrated in FIG. 1 is substantially a centralized architecture with respect to the production 120, admin 130 and sandbox 140 modules or systems. However, it is also possible to implement an embodiment of the invention in a distributed architecture where services, computation resources, and data are distributed across multiple devices, e.g., a server farm or multiple devices, each performing some of the functionality. Information may come from many sources both within and outside of the distributed architecture. Data may be stored in more than one place with data physically distributed and/or replicated in different devices or storage units, through data sharing and caching. All or some of the functionality of a computing system or platform may be implemented in a cloud based architecture (such as a multi-tenant system), where one or more of a system's services, functionality or data are physically hosted in one or more remote data centers (as illustrated in FIGS. 3 and 4).

Furthermore, while systems are shown as centralized, e.g., client or enterprise systems, each system may have, for example, multiple systems related to separate enterprise customers with their own domains in a shared resource environment. For example, different enterprises may move their services to a common resource service.

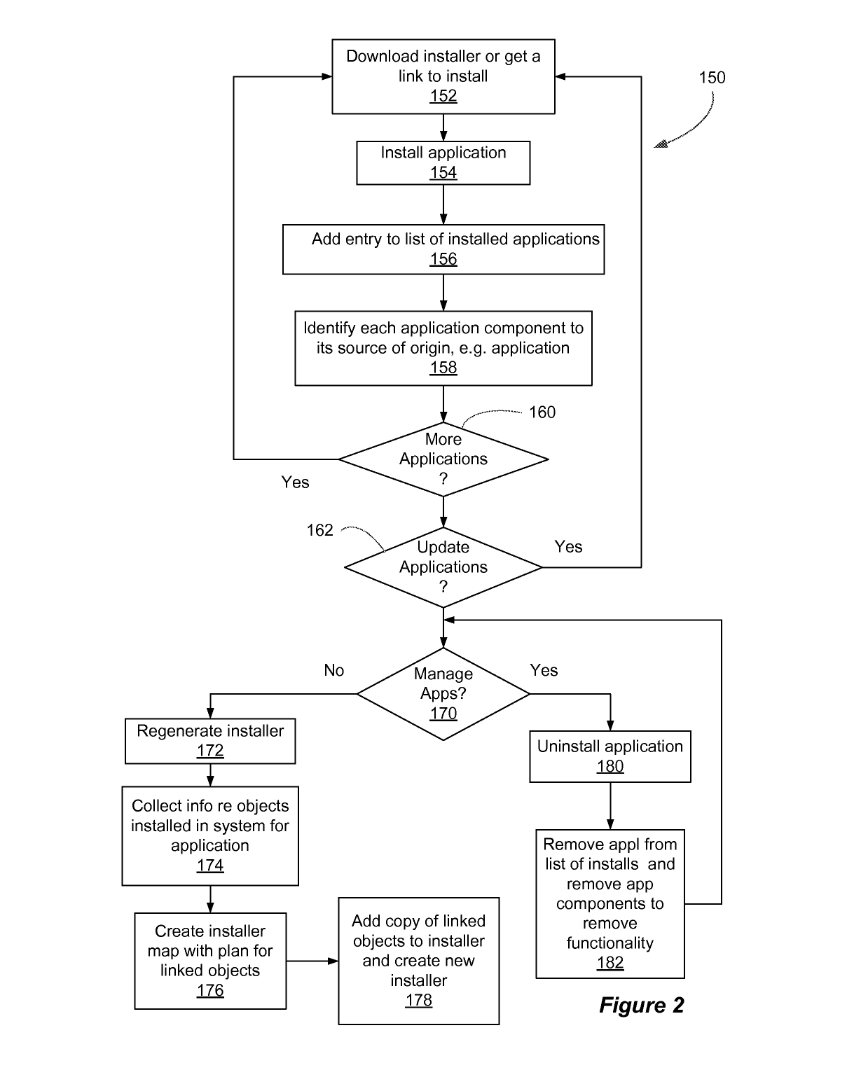

FIG. 2 is a control flow diagram illustrating one example of a process, method, operation, or function 150 for regenerating an installation package in accordance with some aspects of the present invention. Initially, the process 150 of FIG. 2 illustrates steps commonly taken when installing applications on a target system. Installation is initiated leading to the downloading of an installer package or a link to an install package at step 152. The application is installed at step 154 and an entry is added to a list of installed applications on the target system at step 156. At step 158, each application component is identified with regards to its source of origin, e.g., the application for which it was downloaded and installed. If more applications are to be installed, at step 160, control flow returns to step 152 to install the next application.

If there are no additional applications for download, then control flow branches at step 160 to step 162, where a check is performed for updates to installed applications. If there are updates, then control flow branches at step 162 to the download step 152 to download an update package, installation of the update at step 154, adding an entry to the list of installed applications indicating the update version at step 156, and identifying any application components that were installed during the update along with the application that was updated at step 158.

If there are no further updates, then control flow proceeds from step 162 to step 170 in order to process either uninstall application requests or regenerate installer requests. If there are applications to be uninstalled, then control branches to step 180 where the application is uninstalled and step 182 to remove the application and its components from the list of installed applications and application components. Control branches back to step 170 to check whether any other applications are to be uninstalled.

If there are no applications to be uninstalled, then control branches from step 170 to step 172, where the installer package is regenerated. Information is collected about objects installed in the system for the application at step 174. An installer map is created at step 176 that includes a plan of linked objects to be included in the installation. At step 178, a copy of the linked objects is added to the installer and the new installer is regenerated that includes the identifier value for the original installation of the application, which facilitates later updating of the application.

The regenerated installer package produced by process 150 may be utilized as the basis for installation of the application on other target systems or subsequent updates to an installed application wherein the install package is modified to reflect the updated components and provide linkages to these objects. The process may be applied to a variety of operating systems, a cloud account, or an equivalent target platform.

As noted, in some embodiments, the invention may be implemented in the context of a multi-tenant, “cloud” based environment (such as a multi-tenant business data processing platform), typically used to develop and provide web services for end users. This exemplary implementation environment will be described with reference to FIGS. 3 and 4. Note that embodiments of the invention may also be implemented in the context of other computing or operational environments or systems, such as for an individual business data processing system, a private network used with a plurality of client terminals, a remote or on-site data processing system, another form of client-server architecture, another form of software development environment, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, and web-based customer support, as well as reporting and analysis capabilities relating to these functions. With differing levels of overlap with ERP/CRM initiatives and with each other, efforts have also been directed toward development of increasingly integrated partner and vendor management systems, web store/eCommerce systems, product lifecycle management (PLM) systems, and supply chain management (SCM) systems.

FIG. 3 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 224 may include one or more data stores, which may include a Service Data store 225 and one or more Tenant Data stores 226.

Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 may be a multi-tenant platform and be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of an integrated service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system/platform (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 3 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, etc. A web server is a most often a combination of hardware and the software that helps deliver content (typically by hosting a website) to client web browsers that access the web server via the Internet.

Rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs. Each tenant may be a business or entity that uses the multi-tenant platform to provide business data and functionality to multiple users. Some of those multiple users may have distinct roles or responsibilities within the business or entity. As a result, such users may have a need or preference to utilize different applications for performing their functions. Embodiments of the invention provide a method for recreating application installation packages installed in a secure computing environment, e.g., a sandbox that allows for more efficient administration of the production and distribution of applications and extensions in a cloud-based environment.

In some cases, a tenant may desire to modify or supplement the functionality of an existing platform application by introducing an extension to that application, where the extension is to be made available to the tenant's employees and/or and customers. In some cases such an extension may be applied to the processing of the tenant's business related data that is resident on the platform. The extension may be developed by the tenant or by a 3^{rd} party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers, or to cause their business data to be processed in a specific way in accordance with a defined workflow that is tailored to their business needs, etc.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

As noted, in addition to user customizations, an independent software developer may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension.

FIG. 4 is a diagram illustrating additional details of the elements or components of the multi-tenant distributed computing service platform of FIG. 3, in which an embodiment of the invention may be implemented. The software architecture depicted in FIG. 4 represents an example of a complex software system to which an embodiment of the invention may be applied. In general, an embodiment of the invention may be used in conjunction with or as part of a development environment for any set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 4 is a diagram illustrating additional details of the elements or components 300 of the multi-tenant distributed computing service platform of FIG. 3, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols. As described herein, embodiments of the invention provide a method for recreating application installation packages installed in a secure computing environment in a production and distribution system.

The application layer 310 may include one or more application modules 311, each having one or more sub-modules 312. Each application module 311 or sub-module 312 may correspond to a particular function, method, process, or operation that is implemented by the module or sub-module (such as a CRM, ERP, eCommerce function or task). Such function, method, process, or operation may include those used to implement one or more aspects of the inventive system and methods, such as for:
Using an application installation package to install an application in a secure computing environment; and
Regenerating the application installation package based on the information collected regarding objects installed in the secure computing environment for the application, creating an installer map with a plan for the linked objects, and adding a copy of the linked objects to the installer package to recreate the application installation package.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 3) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3 and 4 are not intended to be limiting examples. Alternatively, or in addition, computing environments in which an embodiment of the invention may be implemented include any suitable system or environment that permits administrators to develop installer packages for software applications in a production environment, which may include the use of a secure computing environment. Although further examples below may reference the example computing environment depicted in FIGS. 3 and 4, it will be apparent to one of skill in the art that the examples may be adapted for alternate computing devices, systems, apparatuses, processes, and environments.

In accordance with at least one embodiment of the invention, the system, apparatus, methods, processes and/or operations described herein for regenerating an application definition may be wholly or partially implemented in the form of a set of instructions executed by one or more programmed computer processors, such as a central processing unit (CPU) or microprocessor. Such processors may be incorporated in an apparatus, server, network element, client or other computing device operated by, or in communication with, other components of the system.

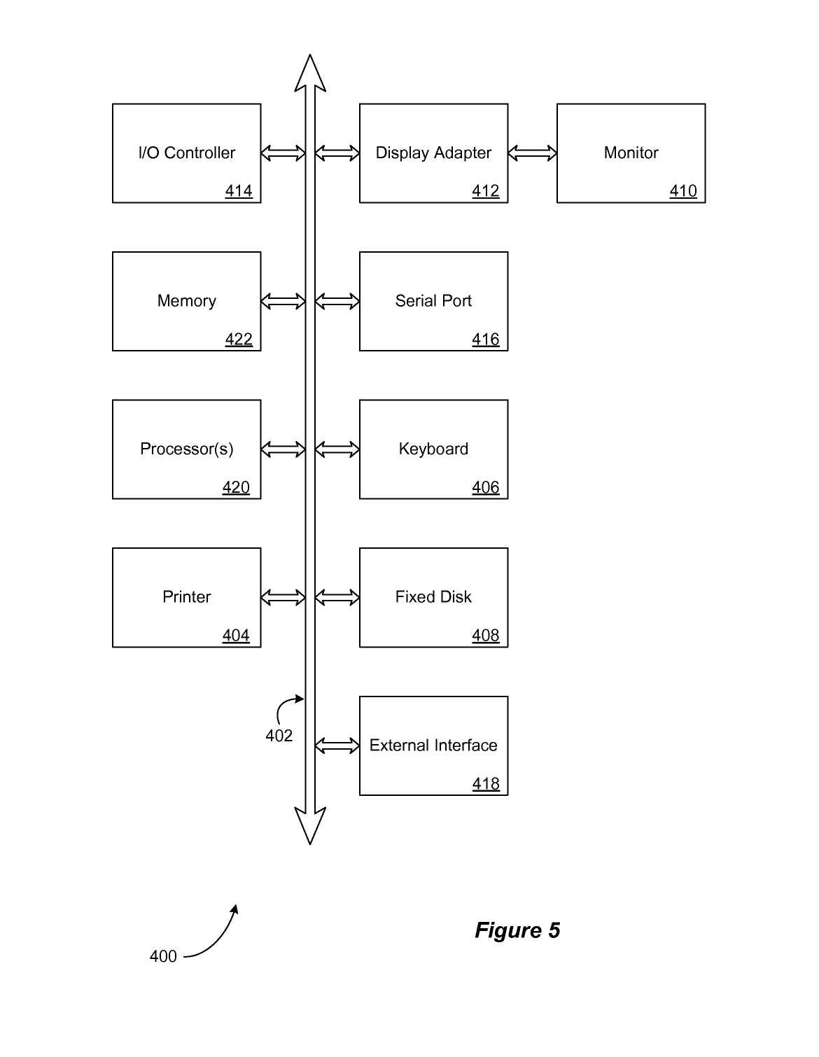

As an example, FIG. 5 is a schematic diagram depicting aspects of a non-limiting, exemplary computing architecture suitable for implementing at least some embodiments of the present methods and systems. By way of a non-limiting example, FIG. 3 depicts aspects of elements that may be present in a computer device and/or system 400 configured to implement a method and/or process in accordance with some embodiments of the present invention. The subsystems shown in FIG. 5 are interconnected via a system bus 402. Additional subsystems include a printer 404, a keyboard 406, a fixed disk 408, and a monitor 410, which is coupled to a display adapter 412. Peripherals and input/output (I/O) devices, which couple to an I/O controller 414, can be connected to the computer system by any number of means known in the art, such as a serial port 416. For example, the serial port 416 or an external interface 418 can be utilized to connect the computer device 400 to further devices and/or systems not shown in FIG. 5 including a wide area network such as the Internet, a mouse input device, and/or a scanner. The interconnection via the system bus 402 allows one or more processors 420 to communicate with each subsystem and to control the execution of instructions that may be stored in a system memory 422 and/or the fixed disk 408, as well as the exchange of information between subsystems. The system memory 422 and/or the fixed disk 408 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. A method for automatically regenerating an application installer, the method comprising the steps of:
installing an application in a computing environment;
collecting information for objects related to the application installed in the computing environment;
creating an installer map listing objects linked to the installed application in response to collecting the information;
adding a copy of the linked objects to an application installer package for the installed application;
creating, using a computer processor, a regenerated application installer based on the application installer package for the installed application; and
storing the regenerated application installer in a computer memory associated with the computer processor.

2. The method for automatically regenerating an application installer of claim 1, where the computing environment further comprises a secure computing environment.

3. The method for automatically regenerating an application installer of claim 2, where the application installer is automatically regenerated when the secure computing environment is refreshed.

4. The method for automatically regenerating an application installer of claim 2, where the secure computing environment replicates at least one of a distributed computing service and a distributed computing platform.

5. The method for automatically regenerating an application installer of claim 2, where the secure computing environment replicates at least one of a multi-tenant distributed computing service and a multi-tenant distributed computing platform.

6. The method for automatically regenerating an application installer of claim 1, where the computing environment comprises at least one of a distributed computing service, a distributed computing platform, a multi-tenant distributed computing service, and a multi-tenant distributed computing platform.

7. The method for automatically regenerating an application installer of claim 1, where the linked objects include at least one of components, features, package logic, meta-data, and system data that defines execution of the application installer package, information describing the application installer package, an identifier for the installed application, version information and dependency information.

8. A computer system for automatically recapturing and rebuilding an application installer, the computer system comprising:
a computer processor being configured to:
install an application in a computing environment;
collect information for objects related to the application installed in the computing environment;
create an installer map listing objects linked to the installed application in response to collecting the information;
add a copy of the linked objects to an application installer package for the installed application; and
create a regenerated application installer based on the application installer package for the installed application.

9. The computer system of claim 8, where the computing environment further comprises a secure computing environment.

10. The computer system of claim 9, where the system is further configured to automatically regenerate the application installer when the secure computing environment is refreshed.

11. The computer system of claim 9, where the secure computing environment replicates at least one of a distributed computing service and a distributed computing platform.

12. The computer system of claim 9, where the secure computing environment replicates a multi-tenant distributed computing platform.

13. The computer system of claim 8, where the computing environment comprises at least one of a distributed computing service, a distributed computing platform, and a multi-tenant distributed computing platform.

14. The computer system of claim 8, where the linked objects include at least one of components, features, package logic, meta-data, and system data that defines execution of the application installer package, information describing the application installer package, an identifier for the installed application, version information and dependency information.

15. A non-transitory computer readable medium having computer-executable instructions stored thereon which, when executed by a computer, will cause the computer to perform a process for automatically regenerating an application installer, the process comprising the steps of:
installing an application in a computing environment;
collecting information for objects related to the application installed in the computing environment in which an installed application is installed;
creating an installer map listing objects linked to the installed application in response to collecting the information;
adding a copy of the linked objects to an application installer package for the installed application;
creating, using a computer processor, a regenerated application installer based on the application installer package for the installed application; and
storing the regenerated application installer in a computer memory associated with the computer processor.

16. The non-transitory computer readable medium of claim 15, where the computing environment further comprises a secure computing environment.

17. The non-transitory computer readable medium of claim 16, where the application installer is automatically regenerated when the secure computing environment is refreshed.

18. The non-transitory computer readable medium of claim 16, where the secure computing environment replicates at least one of a distributed computing service and a distributed computing platform.

19. The non-transitory computer readable medium of claim 16, where the secure computing environment replicates at least one of a multi-tenant distributed computing service and a multi-tenant distributed computing platform.

20. The non-transitory computer readable medium of claim 15, where the computing environment comprises at least one of a distributed computing service, a distributed computing platform, a multi-tenant distributed computing service, and a multi-tenant distributed computing platform.

21. The non-transitory computer readable medium of claim 15, where the linked objects include at least one of components, features, package logic, meta-data that defines execution of the application installer package, information describing the application installer package, an identifier for the installed application, version information and dependency information.
